(19) United States
(12) Patent Application Publication
(10) Pub. No.: US 2011/0301882 A1
(43) Pub. Date: Dec. 8, 2011

(54) SYSTEM AND METHOD FOR PASSIVE ACOUSTIC MONITORING OF FLUIDS AND SOLIDS IN PIPE FLOW

(76) Inventor: Morten Ivar Andersen, Radal (NO)

(21) Appl. No.: 13/202,158

(22) PCT Filed: Feb. 23, 2010
(86) PCT No.: PCT/EP2010/052275

§ 371 Date: Aug. 18, 2011

(30) Foreign Application Priority Data
Feb. 23, 2009 (NO) 2009 0829

(51) Int. Cl. G06F 19/00

(52) U.S. Cl. 702/54; 702/56

(57) ABSTRACT

The invention relates to a system or method for measuring and analyzing acoustic signals from a pipe, e.g. from solid particles or cleaning pigs transported with fluid flow in a pipe, the method comprising the following steps: *registering acoustic signals generated in the pipe in at least one time window, *splitting the signals in a number of frequency bands, *processing the filtered signals to calculate characteristics of the fluid flow in a pipe, the characteristics including mean and deviation of the signal in each frequency band, the characteristics being indicative of possible events occurring in the pipe.

The present invention generally relates to a system and signal processing method for passive acoustic monitoring of fluid and solids flow in a pipe or similar, and use thereof. It specifically relates to acoustic detection and measurement of sand and solids in oil/gas/water flow, and also detection of cleaning pigs injected into process piping in order to abrade and remove deposit build-up on the inside pipe wall.

Passive acoustic technology as described in NO301948, 319877 and 321704 is widely acknowledged to provide a sensitive and cost-efficient means for sand/solids particle detection in fluid flow. Continuous measurement and monitoring of sand/solids in fluid flow helps an operator to assess and avoid potentially critical and costly erosion wear, better control and manage sand handling down-stream, and optimize the production rate for individual wells, all to obtain maximum profit while ensuring safe operations. In recent years, field operators have shifted focus from seeking ‘maximum sand free rates’ to aiming for ‘acceptable sand production rates’, as this can give substantial production gains for wells with low or manageable erosion potential. Reliable and accurate quantification of sand production rate has then become increasingly important.

The basic detection principle for sand is simple: A sensor/detector mounted externally on the pipeline acts as microphone for the ultrasonic frequency range, picking up acoustic noise induced by particle impingement or scouring against the inside pipe wall. The installation point is typically set immediately after a bend, at the outer side, where pipe geometry and particle inertia work to increase the concentration and force of particle impact, and thereby sand response. Installation at a pipe constriction or flow obstacle may be an alternative, and sensor mounting may equally be intrusive and in contact with the process fluid(s) as described in international patent application WO 2005/121770 or U.S. Pat. No. 5,257,530.

Equation (1) gives a simplified expression for sand rate calculation based on recorded noise levels, as implemented for one existing system.

$$Sand rate = \frac{NL - G ( {v}_{c} )}{{F ( {v}_{c} ) \vert}_{1 g / s}} [ g \text{/} s ] \qquad ( 1 )$$

NL=measured noise level (Raw Data) [100 nV]
v_{c}=current flow velocity [m/s]
G(v_{c})=background noise at current flow velocity [100 nV]
F(v_{c})|_{1 g/s} sand noise for 1 g/s sand rate at current vel. [100 nV]

Passive acoustic sand detection is principally a relative measurement. The total noise level, NL, will include not only sand-induced noise but also components of fluid flow noise, sensor self noise, and potentially alien noise originating e.g. from nearby valves or machinery. For quantitative sand measurement the level of such ‘background noise’ G(..) is first subtracted to isolate sand noise level (numerator of Eq. 1), which in turn is converted to sand rate by division with a reference sand noise level F(..) representing a rate of 1 gram/sec. (Not accounting for a known non-linearity; not discussed here).

The level of background noise is generally an increasing function of fluid flow velocity, but is also influenced by parameters such as gas/oil-ratio, water cut, pressure, temperature, pipeline material/dimension/configuration and mounting/coupling. Targeting good accuracy one would therefore normally need to rely on a Background Noise Calibration on site for each individual detector. This typically involves a charting of background noise level over a representative flow velocity range and establishment of a fitted function curve or some form of look-up table. (One could also apply corrections accounting for flow parameter variation, e.g. using external flow input or extracted signal features into empirical models). The level of noise exceeding a set look-up value of background noise is since ascribed to sand production, i.e. classified as ‘sand noise’.

Sand Calibration is concerned with determining the flow dependent reference F(..) relating the level of sand noise to actual sand rate; typically implemented in the form of a fitted function curve or look-up table, similar to the above. This is best established through tests on site with injection of sand at reference rate directly into the fluid flow. If injection tests are not an option (e.g. subsea), calibration may otherwise typically involve the tuning of a default set-up—incorporating input such as sand model calculations, sand trap measurements, or other available reference data.

Passive acoustic sand detection systems have for many years been successfully used in the oil and gas industry—but still have a significant potential for improvement. One special challenge is given by the relative nature of the measurement (cf. Eq. 1) and the fact that ‘background noise’ as a function of flow velocity is rarely static over time, e.g. due to changes in flow composition or flow regime. If calibration drifts off, such that true background noise level is no longer correctly represented, the sand rate output will correspondingly be either under- or over-estimated. Some degree of manual data interpretation and follow-up is therefore normally required to ensure a best possible accuracy, and if not awarded attention the system performance may suffer over time. Several techniques have been developed to alleviate the effects of the mentioned flow dependency, and also to extract flow data independently of external input. One example is the ABA-function (Automated Background noise curve Adjustment) described in Norwegian Patent No 323248. Other examples include e.g. cross-correlation velocity measurement described in Norwegian Patent No 319877, and flow measurement using an active pulse-doppler technique described in product brochure ‘ClampOn SandQ™’ (August 2008). The ClampOn SandQ product also operates in several ultrasonic frequency ranges simultaneously, permitting the implementation of certain unspecified signal processing features.

Another known system is discussed in U.S. Pat. No. 5,083,452. In this case a constriction is used in the flow. The signal is processed by FFT and the spectral distribution of the different frequency components in the acoustic signal is analysed. The system requires complex analyzing methods such as multivariate analysis

The present invention aims for improvement over existing solutions on several levels:
Increased detection robustness and thereby measurement accuracy by improved discrimination of sand-induced noise and ‘unwanted noise’, including turbulent flow noise using simple analysis methods.
Additional output parameters to provide analysis and diagnostics tools for increased understanding of and confidence to primary output.
Provide new input and flexibility for tailoring of system set-up to each specific installation
Provide means for automated adaptation of frequency range with changing flow conditions
Provide flexible means for enhancing special signal features characteristic for the measurement at hand, both in time and frequency

These objectives are met with the system as mentioned above and being characterized as stated in the accompanying claims.

The invention is based on the realization that noise characteristics in both time and frequency domains may provide information about what is happening inside the pipe. The preferred embodiment of the invention regularly captures and samples short time segments of noise, and for each single capture, digital signal processing (DSP) is employed to extract a ‘frequency signature’ for M separate frequency bands, with M output values representing mean noise power or RMS level within each band. Considering a sequence of many consecutive noise captures, the output within each separate band may be seen to represent an averaged or ‘reduced’ time signal.

A significant data reduction is thus obtained while preserving valuable information in both time and frequency domains. Statistical parameters are since used to extract and enhance specific signal features from the reduced time signal within each band, for both measurement and analysis/diagnostics purposes. Finally, statistical parameters are combined to produce measurement-specific output for a selected frequency range or set of frequency bands, as found suitable for the application at hand. In addition to seeking enhanced overall system performance, one important motivation for the invention has been to obtain operator access to more of the source information contained in the acoustic noise signal—in an installation environment where communication bandwidth is often limited. The number of bands, two or more, may be chosen according to the total frequency range and expected acoustic signal, and preferably the number of bands is set sufficiently large to capture and separate measurements of different occurrences in different bands. Processing considerations has lead to the choice of 16 bands in the present embodiment. Both the width and number of bands may also be dynamic depending on the available sensors, signal processing means and situation.

The invention is described below with reference to the accompanying figures/graphs, illustrating the invention by way of examples.

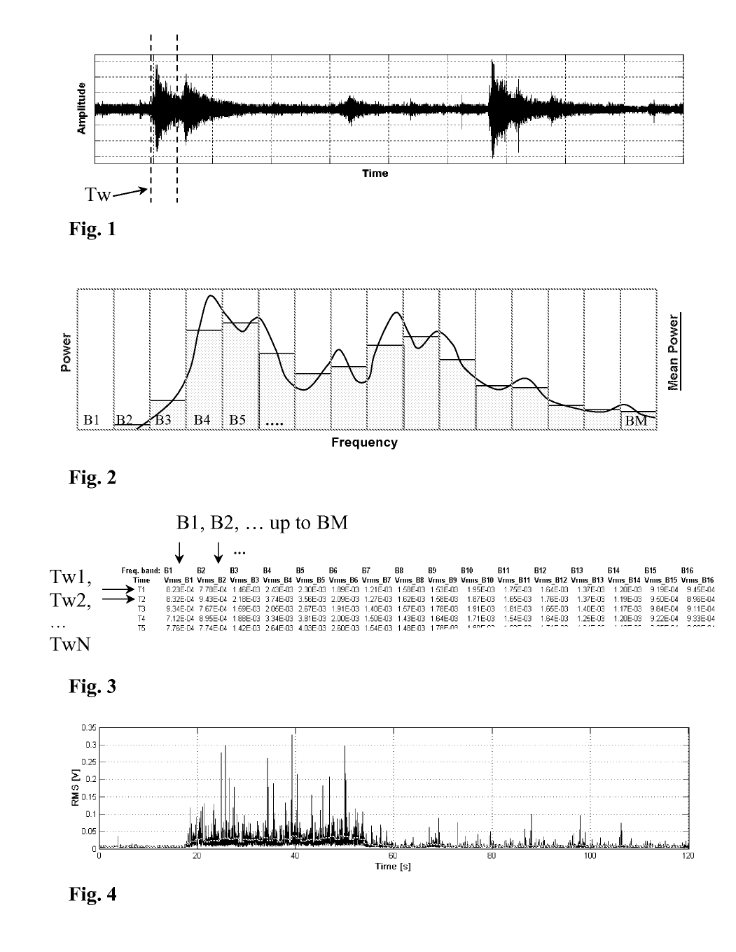

FIG. 1 illustrates a typical full-bandwidth time signal with sand-induced noise (typical range up to ˜1 MHz for sand applications). A typical (single) time window for noise capture and processing is indicated by vertical dashed lines.

FIG. 2 illustrates the power spectrum for a single time window of captured noise (ref. FIG. 1), and corresponding mean power within M separate frequency bands.

FIG. 3 is an illustration of output from basis processing; here window-averaged RMS time signals for M=16 frequency bands.

FIG. 4 illustrates RMS noise level (for bands B7 to B16 combined) recorded during injection of 50 grams of sand into a 4″ pipeline, with two-phase water/air flow at ˜2.9 m/s. The overlain grey curve represents the same data averaged over 1 sec intervals. The main arrival of sand is seen to start at ˜17 sec.

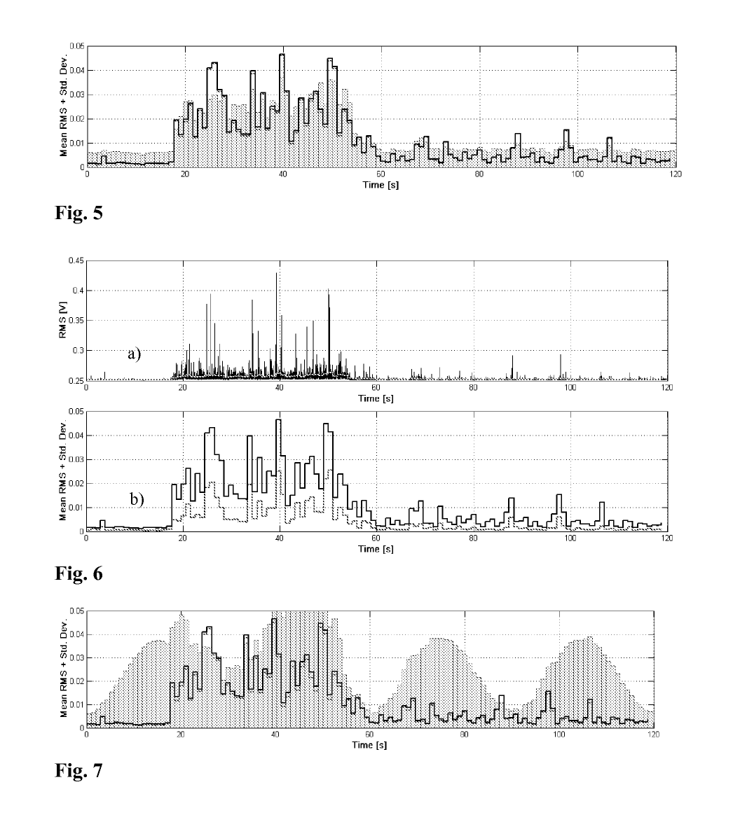

FIG. 5 illustrates a bar graph showing the RMS mean over one second intervals and the step curve illustrates the corresponding RMS standard deviation.

FIG. 6 is an illustration based on the data behind the former example (cf. FIGS. 4 and 5), having introduced a significant sinusoidal disturbance within the pass band for sand detection. Upper graph (a): RMS noise level (for bands B7 to B16 combined). Lower graph (b): The black curve shows the standard deviation based on variance found within individual bands, the grey curve shows the standard deviation based on variance over the combined RMS time signal (shown in (a)).

FIG. 7 Compares with FIG. 5. A slowly varying RMS offset (emulating the effect of broad-band ‘hissing’ from a valve) has been added to all frequency bands in basis processing. The standard deviation (step curve) is little affected.

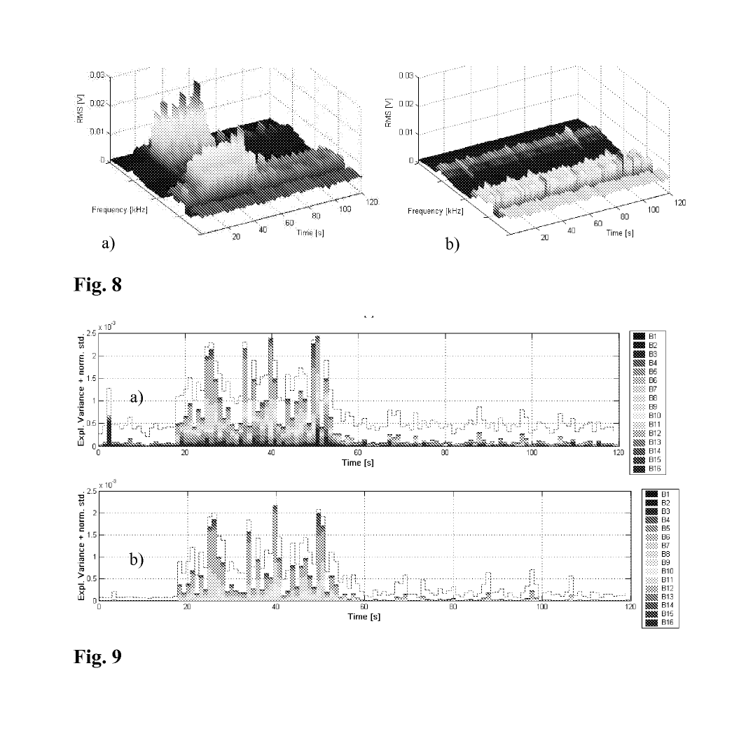

FIG. 8 Time frequency view considering the same sand injection and data set as in former examples (120 sec recording). a): Sand noise with 50 gram sand injection at ˜1 gram/sec. b): Prevailing flow noise as recorded immediately before the sand injection.

FIG. 9—RMS variance over 1 second intervals—shaded/color coded and stacked according to the contribution from each individual frequency band. Upper graph (a):—Including all bands. Lower graph (b): Including bands for a typical frequency range used in sand applications. Overlain grey curve:—Standard deviation based on total variance (normalized for readability).

The following steps outline the regular sequence for data acquisition and processing, also referred to as ‘basis processing’:
1. Capture and sample/digitize a short time segment of full-bandwidth noise data (with typical range up to ˜1 MHz for sand applications). The time window duration is selected to be representative for (or shorter than) the characteristic signal one aims to enhance; here noise bursts arising from sand particles of clusters of particles impacting the inside pipe wall. FIG. 1 gives an example of sand noise amplitude as a function of time. A single time window Tw for data capture is indicated at the left with vertical, dashed lines.
2. Using the time-windowed data as input, employ standard Digital Signal Processing techniques (e.g. Fast Fourier Transform) to calculate the mean power within M separate frequency bands. See illustration in FIG. 2; the full frequency range has here been split into M=16 bands in total.
3. Based on the above, calculate mean RMS level within the M frequency bands (RMS=‘root-mean-square’ level; square root of mean power).
4. Capture the next time segment as soon as possible and repeat steps 1 to 3; continue sequence throughout the total acquisition period (e.g. 1 second). Or better: Capture next time segment while processing the former; ideally seeking seamless data acquisition and processing.

Simplified, operation may be compared with routing the full-bandwidth noise signal through a bank of ideal (infinitely sharp) filters and employing a form of power averaging and down-sampling at the output. The averaging period (i.e. duration of time window in basis processing) is selected to enhance bursts of sand noise and is as such a ‘signal signature filter’ in its own.

In terms of RMS noise levels the resulting output may be illustrated by a matrix; see FIG. 3: Each separate column B1, B2, . . . BM represents a ‘filtered’ and window-averaged time signal confined to one specific frequency band. Each row entry may equivalently be seen to represent a compressed noise frequency spectrum, as found for one specific time window of captured noise.

Features of the present invention:
Extracts information in both time and frequency domains while obtaining significant data reduction
Processing load is distributed evenly over the acquisition period, minimizing a ‘blind zone’ for detection
Resolution in time domain is configurable and may be set to enhance specific signal features
Configurable resolution also in frequency domain; the size of the ‘filter bank’ may be extended at little extra processing cost during acquisition
‘Digital filtering’ may since be reduced to simple exclusion or inclusion of bands. RMS time signals for a selected set of frequency bands may combined by finding the square root of combined power−summarized over selected column entries within each row (where power=RMS squared). Two or more of the frequency band columns may in other words readily be combined to one in order to represent a wider frequency range.
Provides simple and flexible means for frequency range selection and exclusion of ‘problem bands’; e.g. for tailoring of system set-up to a specific installation and for automated adaptation of frequency range with changing flow conditions.
Provides simple and processing efficient means for extracting statistical parameters from noise signals within selected frequency bands
Provides a powerful platform for tailoring measurement specific output parameters to the measurement at hand, utilizing both time and frequency information

In order to make the most of the possibilities offered, a preferred implementation of the invention may involve use of a broad-band acoustic sensor, i.e. a sensor covering a wide range of frequencies.

Considering frequencies up to ˜1 MHz for sand applications, flow noise is most dominant in the lower frequency range, while sand noise is typically more prominent in a higher frequency range. But there is a large degree of frequency overlap which is also strongly flow dependent. Use of a fixed frequency range is therefore not ideal when seeking to separate flow noise and sand noise as much as possible.

Regarding the frequency distribution of sand noise one generally finds a relative increase in high frequency (HF) content with smaller particle size and higher flow velocity, while the overall level of sand noise increases with increasing flow velocity. For a set velocity, sand noise response also increases with particle size provided that the flow supports a proper sand transport. Multiphase flow noise is generally an increasing function of flow velocity, with components in the HF range increasingly becoming a factor with stronger turbulence.

In light of the above, full separation of sand noise and flow noise by simple frequency filtering is not practical. The discrimination will however often benefit from sharp filtering—if filtering range is adapted to the specific installation and the prevailing flow conditions. The present invention provides simple means to implement such functionality. Firstly, the frequency distribution of noise is continuously available for analysis and use into algorithms. Secondly, frequency selection and sharp filtering is reduced to simple selection and re-combination of bands from basis processing (see bulleted list of features). Linking band selection to e.g. flow velocity (and/or other flow parameters) gives a promising potential for improved sand monitoring. For high velocity wells it would e.g. be useful to cultivate the HF response by excluding lower frequency bands more affected by flow noise, while for low velocity wells—where sand transport and HF response may be poor while flow noise is a lesser factor—lower frequency bands may be included to enhance overall sand response. Note that such band selection may be automated once initially set up for a specific installation. Note also that more complex and processing-intensive digital filtering in a standard sense can be avoided.

Existing passive acoustic sand detection systems normally use some form of average noise level into the quantification algorithms, having applied a typical averaging period in the range of 1 second. The noise signal itself is also band-pass filtered; this could include both analog and digital filtering. For reference in coming examples, output from basis processing has in some cases been used to emulate the output of existing systems by averaging RMS noise level over 1 second intervals—having combined frequency bands corresponding to a typical pass band for sand detection.

Moving onto examples of output from basis processing, FIG. 4 shows RMS noise levels as a function of time recorded during injection of sand at ˜1 gram/second into a 4″ pipeline—under conditions of two-phase water/air flow at ˜2.9 m/s. With reference to the former matrix illustration in FIG. 3, time-windowed RMS signals for frequency bands B7 to B16 have in this case been combined to an ‘effective’ RMS signal representative for a typical sand detection pass band. The overlain grey curve shows the same data when averaged over 1 second intervals—emulating noise level output similar to that of an existing system.

As a first impression it is striking to see how the characteristic sand-induced ‘spikes’ are much lost with averaging. Looking at the grey curve (averaged noise level) the main sand injection could be well detected above a user-set background noise threshold, but the trail of late and weaker sand noise deflections is more or less suppressed by averaging and could at least not be detected with confidence. This illustrates a limitation of existing systems: Small variations in mean noise level cannot confidently be ascribed to sand due to ambiguity with flow noise, and e.g. a gradually rising trend may reflect a steady and increasing sand production or changes in flow regime/composition and thereby flow noise. (A whole range of flow combinations may represent the same mixed flow velocity). One is too often dependent on an operator's subjective interpretation of data output and following parameter adjustment, and the grounds for interpretation may at times be weak—even for a skilled user. It is evident that the characteristic sand response could be better exploited to improve detection capability and also support more substantial and confident interpretation.

One potential path to improved noise discrimination is to detect sand from the signal remaining when a noise offset or baseline is removed, treating the characteristic sand response as being a superimposed ‘deviation signal’. A suppression of overall response level will be an acceptable price to pay if the end-result can be a more robust and hassle-free system. There are several possible implementations; one is to calculate the standard deviation of RMS noise over set intervals of e.g. 1 sec. (with a tentative 1 sec update rate of output in mind). The RMS mean is then effectively discarded (inherently treated as baseline) and one enhances the narrow peaks more characteristic for sand noise. Performance is best illustrated by example—using the same data set as above: In FIG. 5 the bar graph represents RMS mean over 1 second intervals (emulating output similar to that of an existing system), while standard deviation is given by the overlain step curve. A promising correlation can be seen if standard deviation is now visually compared with the full-resolution RMS sand response in FIG. 4.

Standard deviation is found as the square root of variance, which in turn involves a square operation that gives a relatively stronger weighting the stronger outliers in a set of recorded readings. As a result, standard deviation tends to enhance the ‘peakier’ noise level readings. Comparing FIG. 5 and FIG. 4, notice how the trail of late and weaker sand arrivals is now resolved and identifiable also at 1 second update rate.

FIG. 5 actually shows two coinciding step curves, one black and one grey (largely masked behind), representing two alternative implementations of standard deviation. In the case of the grey curve, standard deviation is calculated directly from the combined RMS time signal (as shown in FIG. 4), after merging of selected bands. In the second case (black step curve), the RMS variance is first calculated for each separate band/matrix column and added to produce a total variance for all selected bands in the frequency range used (considering variance as a figure for ‘deviation signal’ power), and standard deviation is finally found as the square root of the combined result. In the example shown the two alternative implementations produce nearly identical output. The second option is however much preferred due to superior performance in the presence of unwanted noise (to be shown).

Testing has indicated that flow noise within a typical pass band for sand detection contributes relatively more to noise offset than to variance/standard deviation. The described technique therefore helps to suppress flow noise relative to the sand noise deviation signal, strengthening an improvement already obtained with sharper filtering. Finally, the initial splitting and later processing of time signals confined to a number of narrower frequency bands helps to enhance the characteristic sand-induced ‘spikes’ in the presence of unwanted noise (see example below).

Assume that e.g. nearby machinery introduces a strong sinusoidal disturbance within the pass band for sand detection, resulting in a significant RMS offset in one of the bands in basis processing. This is illustrated in FIG. 6—having simulated the effect on data from the former example. As before, RMS signals for selected frequency bands have been combined to an ‘effective’ RMS signal representative for a typical sand detection pass band. (Note the offset y-axis for upper graph (a)). In the lower graph (b), the black step curve represents standard deviation based on processing within separate frequency bands, and comparison with FIG. 5 reveals little influence of the strong noise disturbance. The grey step curve on the other hand, representing standard deviation if it were calculated directly from the combined RMS time signal, is noticeably taken down. The reason is that a relatively higher noise offset in one or more bands will tend to mask the variance in the total response, while when treating bands separately, a contaminating offset in one band will exit the equation, leaving contributions from other bands unaffected. In sum, the splitting of processing into several frequency bands helps resolve the characteristic sand-induced ‘spikes’. (Note: Mean RMS would here be offset outside the axes and is therefore not shown).

With limited availability of suitable installation points on a pipeline it is not always possible to set up the desired separation distance between a sensor and known sources or disturbing noise, e.g. choke valves. Choke noise is a known problem issue for passive acoustic sand detection systems; typically producing excessive levels of background noise that also vary with e.g. pressure fluctuations. Sand response may then be difficult to resolve confidently and standard calibration may not be an option. As a result, system performance can suffer greatly.

Assume now that choke noise at a given installation produces a form of broad-band ‘hissing’ in the frequency range of interest for sand detection, contributing relatively more to RMS offset than variance/standard deviation over set acquisition intervals of e.g. 1 second. The present invention could then potentially support robust sand detection under conditions not presently tackled well by existing systems. For illustration, pressure-modulated ‘hissing’ from a valve has been emulated with the same data used in former examples—by adding a slowly varying RMS offset to all frequency bands in basis processing. As seen from the graphed output in FIG. 7, standard deviation within the selected pass band is little affected by the added disturbance, despite significant offset level and fluctuation over time.

As previously described the standard deviation parameter gives a relatively stronger weighting to outliers in a data set and thus tends to enhance the ‘peakier’ RMS readings characteristic for sand noise. This could prove particularly helpful for sand detection on low velocity ASR wells, where better sand control is in strong demand while poor sand response is a problem issue. While flow noise is normally very limited, sparse and relatively weak ‘hits’ by sand particles have little effect on mean noise level. A measurement parameter enhancing outliers, such as described, should then provide a better sand marker. (ASR wells=wells allowed to produce at an Acceptable Sand Rate—for increased production at low and manageable sand erosion potential).

Equation (2) expresses RMS variance over a single band, Bi, with the total acquisition period covering N time window captures.

$${Var}_{Bi} = \frac{1}{N} \cdot {\sum }_{k = 1 , N} {( {RMS}_{k , Bi} - {m}_{Bi} )}^{2} = \frac{1}{N} \cdot {\sum }_{k = 1 , N} {P}_{k , Bi} - {m}_{Bi}^{2} \\ where … \\ {m}_{Bi} = \frac{1}{N} \cdot {\sum }_{k = 1 , N} {RMS}_{k , Bi} , {P}_{k , Bi} = {RMS}_{k , Bi}^{2} \qquad ( 2 )$$

Bi=frequency band no i,
k=time frame index within total acquisition period,
N=no. of time frames within total acquisition period
m_{Bi}=mean RMS, band Bi
P_{k,Bi}=power, time frame k, band Bi

Standard deviation (square root of variance) is defined as the root mean square deviation of values from their mean, while in this context one would ideally pick out variation about a representative baseline of noise. Looking to the example data in FIG. 4 it is easy to realize that RMS mean would poorly represent a baseline for sand-induced ‘spikes’ in cases where sand rate is excessively high, and performance may be refined by introducing an alternative baseline estimator m_{Bi} into the above expression (disregarding the precise statistical definition of variance).

Candidate examples e.g. include:
m_{Bi}=minimum RMS_{k, Bi} over acq. period
m_{Bi}=median of RMS_{k, Bi} over acq. period (3)
m_{Bi}=n th order statistic, i.e. n th smallest RMS_{k, Bi} over acq. period

Statistical parameters other than standard deviation are also of strong interest for use into new and improved measurement algorithms, not only for sand detection/quantification but also applications such as pig detection, overflow detection, leak detection, flow characterization, and for analysis and diagnostics purposes—to name a few examples. The last point is a key to facilitate better operator control in terms of optimizing system set-up for best possible performance, and also to enable a better understanding of output and thereby confidence to the measurement(s) provided. Examples of statistical parameters of interest e.g. include:
Mean level: Key words: Sand monitoring, flow characterization, reconstruction of output similar to existing systems, trending of compressed spectrum, frequency range selection/‘filtering’, identification of potential problem bands, pig detection, etc.
Maximum level: Sand monitoring, flow characterization
Minimum level: Flow characterization, noise floor.
Median level: Information on flow conditions, dominant noise level
nth order statistic (i.e. nth smallest noise level over acq. period): Noise floor
Integrated Power:—Band power and mean RMS give variance and eventually standard deviation (Eq. 2), and the separation of band power also opens for alternative implementations (Eq. 3).—Sand monitoring, pig detection, etc.

Statistical parameters each hold valuable information on the process flow, but even more so when seen in combination (while also being assessed in many separate frequency bands).

Moving onto another application, the basic principle for passive-acoustic pig detection is simple: As for sand monitoring an acoustic detector is mounted onto the production pipe and acts as a microphone for the ultrasonic frequency range. Noise is induced in the pipe wall when a cleaning pig moves along on the inside, and a characteristic noise peak is captured as the pig passes the detector location. By certain detection criteria this will flag a ‘Pig passed’ event. Such criteria typically involve applying noise level thresholds and timing constraints in order to discriminate a true pig passed event from noise peaks or level shifts originating from other sources, such as pig launcher valves or flow changes.

The output from basis processing is well suited also for implementation of new and refined techniques for pig detection. As for sand applications one is looking to detect a characteristic signal that rises up from a baseline of noise, and the simple scheme of combining frequency bands will enable a founded adaptation of frequency range to the specific type of pig and pipeline installation at hand. Continuous access to frequency information will also enable a better discrimination of noise from a true pig passage and unwanted noise from e.g. a pig launcher's release valve, specifically for cases where the characteristic time signature are similar for the two.

One technique of potential interest for pig detection is cross-correlation of RMS noise data from two sensors/detectors mounted a set distance apart on the same process pipe. This could provide verification of a pig passing as a moving noise source (as opposed to e.g. launcher noise), and also give actual pig velocity. For cross-correlation one would typically use mean RMS noise within the pass band (several basis bands combined). It would further make sense to reduce data to a ‘sufficient’ time resolution by combining output from several neighboring time windows over the acquisition period.

The output from basis processing, i.e. pre-processed time signals confined to M separate frequency bands, is well suited for implementation of simple analysis tools that may increase confidence to and understanding of measurement data. Examples follow. (Sand detection is used for illustration—but the tools generally apply to characterization of noise, regardless of the noise source).

Considering the same sand injection as in former example, FIG. 8a) gives a 3-D view of the RMS data set from basis processing, with time in seconds along the x-axis (having applied one second time averaging) and frequency (bands) along the y-axis. The marked high-frequency response is here a strong indicator for sand production. FIG. 8b) shows the prevailing flow noise as recorded immediately before the injection.

Again considering the same example, FIG. 9 gives an alternative view of the data. The graphs show RMS variance over 1 second intervals—shaded/color coded and stacked according to the contribution from each individual frequency band (beginning with low frequency at the bottom of the stack). The upper graph (a)includes all bands, while the lower graph (b) includes bands for a typical frequency range used in sand applications. The overlain step curve here represents a normalized standard deviation.

FIG. 8 and FIG. 9 both display information held by only 16 output values per second, considering simple statistical mean and variance within the frequency bands from basis processing. The examples demonstrate a capability for implementation of simple but powerful analysis tools for a new generation passive acoustic monitoring systems.

Summarized the present invention specifically relates to a system and method for measuring and analyzing acoustic signals from a pipe, e.g. from solid particles or cleaning pigs transported with fluid flow in a pipe. The method preferably comprises the following steps:
registering of acoustic noise signals generated in the pipe within limited and consecutive time windows,
splitting of each time-windowed signal into a number of frequency bands while employing a form of data reduction/averaging
calculation of specific signal characteristics at regular time intervals, based on the time-windowed and processed signal output; characteristics including mean and deviation within each frequency band, the characteristics being indicative of possible conditions or events occurring in the pipe.

The characteristics may be chosen so as to fit into a model representing conditions or events to be measured or monitored, for example the presence of solid particles in the flow, or cleaning pigs passing inside the pipe.

The method may also comprise the step of combining at least one of the calculated characteristics from a number of frequency bands—providing a combined processed signal or signal characteristic representing a broader pass band. The process of combining output from several narrower bands may e.g. contribute to improve detection capability and performance by suppressing the influence of certain unwanted noise components.

Alternatively or in addition the calculated characteristics may be compared with a predetermined set of frequency band signature characteristics representative for certain incidents or conditions in the pipe, in order to identify occurrence of such. The predetermined set of signatures may be constituted by the characteristic signature of solid particles in a fluid flowing in said pipe, a pig or other events. Signature parameters may e.g. include band characteristics such as band frequency, mean and deviation, maximum level, minimum level, median level, nth order statistic and integrated power. The predetermined set of signatures may be based on empirical data from previously registered acoustic signals—such as noise induced by different types of cleaning pigs, or noise induced by various types of sand and particle sizes in fluid flow.

It is finally emphasized that the invention is suitable for use in a range of applications involving characterization and/or detection of noise-generating events or conditions. Examples of related applications with fluid-carrying piping e.g. include fluid flow characterization, leak detection, and overflow detection on outlets of separator tanks (ref. Norwegian Patent No 323248).

1. System for analyzing acoustic signals from a pipe or similar, the system comprising at least one acoustic sensor for registering acoustic signals generated in the pipe in at least two time windows, and processing means for processing the acoustic signals, the processing means for processing the signals is adapted to split the signals in at least two frequency bands, each covering a chosen frequency range by using signal processing wherein the processing means is adapted to calculate a set of characteristics for the signal within each of said frequency bands, the characteristics including frequency range of each of said frequency bands and mean value and deviation of the received signals at said frequency bands, the characteristics being indicative for possible events occurring in the pipe, and an analysis tool for analyzing the characteristics in said time windows and frequency bands for detecting said possible events.

2. System according to claim 1, wherein processing means is adapted to combine the calculated characteristics from a number of different frequency bands providing at least one characteristic signal representing a combined pass band.

3. System according to claim 1, also comprising a storage means and comparing means for comparing said calculated characteristics with in said storage a corresponding predetermined set of characteristics comprising characteristic signatures for a number of possible events occurring in the pipe.

4. System according to claim 1, wherein the predetermined set of characteristics comprises the characteristic signature of solid particles in a fluid flowing in said pipe.

5. System according to claim 1, wherein the predetermined set of characteristics comprises the characteristic signature of a pig moving inside said pipe.

6. System according to claim 1, wherein said set of characteristics are based on empirical data from previously registered acoustic signals from collisions between particles and a surface.

7. System according to claim 1, also comprising timing means coupled to said processing means, the processing means thus being adapted to perform said analysis during chosen time windows.

8. System according to claim 1, wherein said characteristics also include at least one of the following: maximum level, minimum level, median level, nth order statistic and integrated power.

9. Method for analyzing acoustic signals from a pipe or similar, the method comprising the following steps:
registering acoustic signals generated in the pipe in at least two time windows,
splitting the signals in at least two frequency bands, each covering a chosen frequency range,
processing the filtered signals to calculate characteristics of the acoustic signal in each of said frequency bands, the characteristics including mean and deviation of the signal in each frequency band, the characteristics being indicative of possible events occurring in the pipe
and analyzing the characteristics in said time windows and frequency bands for detecting said possible events.

10. Method according to claim 9, comprising the step of combining at least one of the calculated characteristics from a number of frequency bands providing a combined processed signal or signal characteristic representing a combined pass band.

11. Method according to claim 9, comprising the step of comparing the calculated characteristics with a predetermined set of characteristics identifying certain incidents in the pipe.

12. Method according to claim 9, wherein the predetermined set of characteristics comprises the characteristic signature of solid particles in a fluid flowing in said pipe.

13. Method according to claim 9, wherein the predetermined set of characteristics comprises the characteristic signature of a pig moving inside said pipe.

14. Method according to claim 9, wherein said predetermined set of characteristics are based on empirical data from previously registered acoustic signals from collisions between particles and a surface and/or a pig.

15. Method according to claim 9, wherein the processing is performed in limited time periods so as to provide a measure in said number of frequency bands, each period lasting a number of time windows.

16. Method according to claim 9, wherein said characteristics also include at least one of the following: maximum level, minimum level, median level, nth order statistic and integrated power.
